(19) United States
(12) Patent Application Publication
(10) Pub. No.: US 2012/0228057 A1
(43) Pub. Date: Sep. 13, 2012

(54) HIDDEN FIRE ESCAPE LADDER SYSTEM WITH SPRING-LOADED STANDOFFS

(76) Inventor: James Barbara, Milford, CT (US)

(21) Appl. No.: 13/045,796

(22) Filed: Mar. 11, 2011

(51) Int. Cl. E06C 9/14

(52) U.S. Cl. 182/93

(57) ABSTRACT

Apparatus for escaping from a building through a window, comprises a plurality of rungs having first and second ends. A first side support is coupled to the first ends of the rungs. The first side support has an upper end. A second side support is coupled to the second ends of the rungs. The first side support has an upper end. A securement assembly is coupled to the wall of a building adjacent a window for providing egress. A first securement secures the upper end of the first side support to the securement member. A second securement secures the upper end of the second side support to the securement member. A plurality of first arms are each positioned proximate the first ends of a respective one of the rungs and are each moveably mounted to go from a retracted position to an extended position. A plurality of first arms are each positioned proximate the first ends of a respective one of the rungs and are each moveably mounted to go from a retracted position to an extended position.

### TECHNICAL FIELD

The invention relates to apparatus and methods for providing a readily accessible fire escape ladder in the context of new construction and replacement window installations, including hidden and external locker retrofits.

### CROSS REFERENCE TO RELATED APPLICATIONS

(Not applicable)

### STATEMENT REGARDING FEDERALLY SPONSORED RESEARCH OR DEVELOPMENT

(Not applicable)

### BACKGROUND OF THE INVENTION

Today, externally applied fire exits are used to escape from large buildings. Most homes, however, do not have a means of escape, particularly from the second or higher floors. People located, for example, on the second floor of a private wood frame home, in the event of a fire in the house are left with the choice of attempting to face unknown dangers and obstacles in navigating an escape through the home or escaping by jumping through a window. This leaves a need for a safe, sturdy, easy to use escape device to allow for an easy exit from a second floor or higher window. It is also desirable to have a device that is not permanently exposed, like a conventional fire escape, as fire escapes typically have a substantial adverse impact on the aesthetic appearance of a home.

### SUMMARY OF THE INVENTION

In accordance with the invention, a fire escape ladder device that can be anchored to a window, or permanently installed under a window and concealed within a wall cavity for quick and reliable deployment comprises a series of rigid rungs. The rungs are supported between a pair of flexible and bendable side supports. The rungs are provided with spring-loaded extendable arms. Alternatively, a spring hinge or other similar self opening mechanism may be used. The rungs can be treated with anti-slip tape, ribbed applications, or abrasive type paint or other material to prevent slipping. The arms are held proximate to their respective rung by locking pins, which are slidably mounted in holes in the rung and arms. The extendable arms may be coated, or capped with a PVC type material, or rubber type coating that protects the house from scratching or marring the house. The pins are connected to a common line secured to an anchor. The line is shorter than the corresponding portion of the flexible and bendable side supports.

Alternatively a stiff wire may be used in place of the pins. If such a stiff wire is used, it may be quite short, for example approximately the height of the box containing the fire escape ladder system. Alternatively a flexible wire which is perhaps twice the height of the box may be used.

When the fire escape ladder is tossed out the window during an emergency situation, the line pulls the pins from the holes in the rungs and arms. Removal of the locking pins releases the arms allowing the springs to cause them to extend from the rungs, leaving the rungs supported by flexible and bendable side supports. The arms may also be held proximate to their respective rung by stiff/rigid wire supports that extend upward from the bottom of the storage box through the corresponding holes in the rungs. In contrast, the flexible and bendable side supports are affixed to both sides of the rungs via metal clamps in such a fashion that the rungs remain in a fixed position with respect to the side supports. Accordingly, the rungs remain secure for a person to descend while being supported away from the side of the house to improve the ease and safety of climbing.

In use, due to the nature of the flexible and bendable side supports, the fire escape ladder can be rolled bunched up or stacked for compact storage and for easy unrolling out of a window and rapid deployment. As the fire escape ladder is being deployed out of a window, a the anchor line pulls the locking pins as the rungs fall to positions further from the anchor point than the length of the corresponding portion of the line. This pulls the locking pins from the holes and releases the arms to be moved by their respective springs, thus opening the extendable arms, or in the case of the stiff/rigid wire supports, once the rung is lifted off the wire support the extendable arms are released by their respective springs, thus opening the extendable arms. Due to the need of a rapid, safe escape from a burning home, the Fire Escape ladder overcomes the flaws of a traditional rope ladder due to the added safety of being supported away from the side of the home, thus allowing a faster and safer descent.

Furthermore the inventive system can be completely concealed within a wall cavity and extended upward through an opening in the window or the interior wood window sill, thus allowing furniture or other items to be used under the window overcoming the flaws of other permanently installed interior permanent fire escape ladders. Another benefit of the fire escape ladder is by using a U-channel rung to house the arm or standoff, a longer extendable arm is used thus providing a greater distance from the house to the rung allowing more room for hand and foot holds providing a safer decent down the ladder.

In accordance with a particularly preferred embodiment of the invention, a ladder rung with a rigid aluminum, steel, rigid PVC or other material for the rung and stepping surface. The rung houses two extendable arms attached on either end to respective flexible and bendable side supports provides a climbing system. The flexible and bendable side supports allow for a small storage space and rapid deployment as the device is released out of a window. As the locking pins are pulled by the cord, automatically a series of extendable arms, driven by springs (or arms made off a springy material which are oriented to want to extend out), swing outward to support the ladder away from the exterior wall of a house, thus allowing a quick, safe decent from a second floor or higher window or in the case of the stiff/rigid wire supports, once the rung is lifted off the wire support the extendable arms are released by their respective springs, thus opening the extendable standoffs. Each device is balanced and mounted to the flexible and bendable side supports such that when the expandable arms are in their open position, the top of the rigid aluminum stepping surface will be perpendicular to the side supports. The stepping surface on the rungs is preferably flat, thus aligning the arms to extend substantially to the ladder and maximize the separation between the flexible and bendable side supports and the outer wall of the home or other building.

### BRIEF DESCRIPTION THE DRAWINGS

The operation of the invention will become apparent from the following description taken in conjunction with the drawings, in which:

FIG. 1 is a rear isometric view of the fire escape ladder device in its closed position with the locking pin in place;

FIG. 1a is an isometric view of a securement for the inventive fire escape ladder;

FIG. 2 is a rear isometric view of the fire escape ladder device in its open position with the locking pin removed;

FIG. 3 is a front exploded isometric view of the fire escape ladder device in its closed position with a detailed view of the internal components;

FIG. 3a is a front exploded isometric view of an alternative fire escape ladder device with an alternative chain link engaging loop structure;

FIG. 4 is a rear isometric view of a partial fire escape ladder Assembly detailing how a series of fire escape ladder Devices are attached in sequence;

FIG. 5 illustrates the complete fire escape ladder assembly in its final open deployment with all expandable arms in their open positions

FIG. 6 is a schematic plan view of a new construction window incorporating the fire escape ladder of the present invention in its stowed position;

FIG. 7 is an alternative schematic plan view of an inventive fire escape ladder in its stowed position in the context of an existing window that has been provided with a ladder hidden in a wall underneath an existing window;

FIG. 8 is an alternative schematic plan view of an inventive fire escape ladder in its stowed position in the context of an external installation retrofit; and

FIG. 9 is an alternative schematic plan view of an inventive fire escape ladder in its stowed position similar to FIG. 6;

FIG. 10 is a schematic view of another alternative implementation of the inventive system; and

FIGS. 11-12 illustrate an alternative new construction window incorporating a fire escape ladder in accordance with the present invention.

### DETAILED DESCRIPTION OF THE PREFERRED EMBODIMENTS

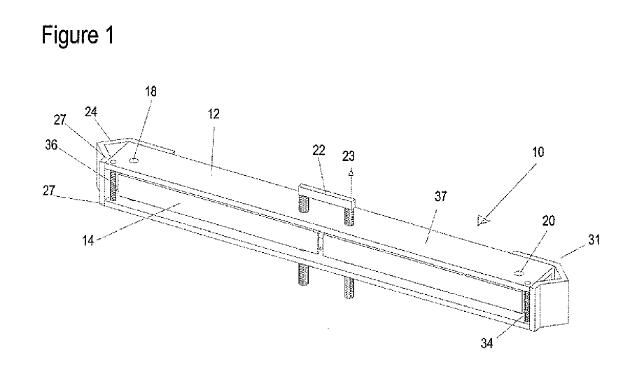

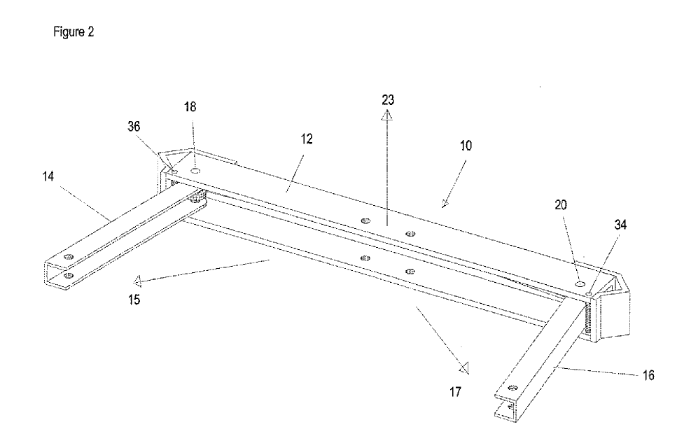

Referring to FIGS. 1 and 1a, the inventive fire escape ladder device 10 comprises a plurality of rungs 12, one of which is illustrated in FIG. 1. Rungs may be ribbed, or may have an anti-slip tape, or abrasive paint applied to the top of the rung to prevent slipping of the rung. Rungs 12 are each supported at their ends by a pair of chains or other supports as described below. Rungs 12 are generally rectangular-shaped in cross-section and made of a rigid metal, such as aluminum or steel car which PVC, or other appropriate material. Each rung 12 is provided with two extendable arms 14 and 16, which are long enough to serve as standoffs for maintaining a gap between the ladder 10 and the side of a building after deployment of the ladder 10. Arms 14 and 16 have holes 15 drilled therein. The extendable arms may have a rubberized coating or pvc caps applied to the ends to prevent damage to the house. Arms 14 and 16 are rotatably mounted on pins 18 and 20. Pins 18 and 20 are friction fitted in holes proximate the ends of rungs 12 as more fully appears below. Extendable arms 14 and 16 have holes, which are slightly larger in diameter than the diameter of pins 18 and 20, thus allowing extendable arms 14 and 16 to freely rotate on pins 18 and 20, as illustrated by arrows 15 and 17.

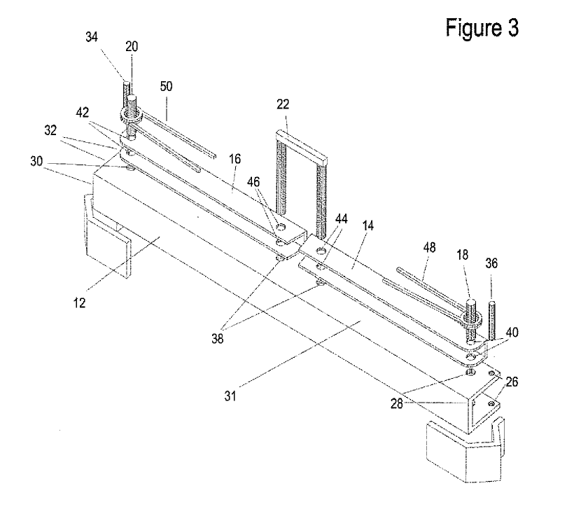

In the stowage position, as illustrated in FIG. 1, extendable arms 14 and 16 are contained inside their respective rung 12. Extendable arms 14 and 16 are locked in place by a locking pin assembly 22, or in the case of the stiff/rigid wire support 22, would be locked in place by the wire support as illustrated in the alternative embodiments below. In the position corresponding to the deployed ladder 10, extendable arms 14 and 16 take the position illustrated in FIG. 2, after movement in the direction of arrows 15 and 17.

Locking pin assembly 22 is roughly U-shaped to allow a cord to be tied or otherwise secured to the yoke portion 23, thus allowing the locking pin to be removed with a single pull or automatically during ladder deployment, as more fully appears below.

As illustrated in FIG. 1a, a bent rigid metal plate securement 24 is bolted, riveted, or welded onto, for example, to the outside of the stepping rung 12 and extending outwardly from the sides to act as a securement for securing rung 12 to flexible and bendable side supports, such as chains 54 and 56 as appears more fully below. Securement may be achieved by, for example, a sheet metal screw 25 (or weld) and a pair of spot welds 27 (or bolts and nuts). Identical securements 24 are employed at opposite ends of rungs 12.

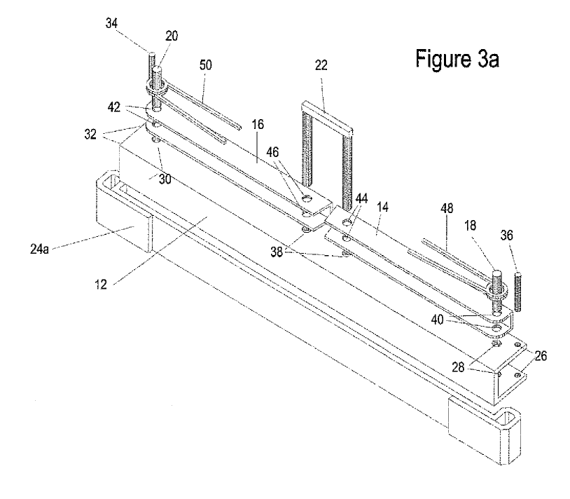

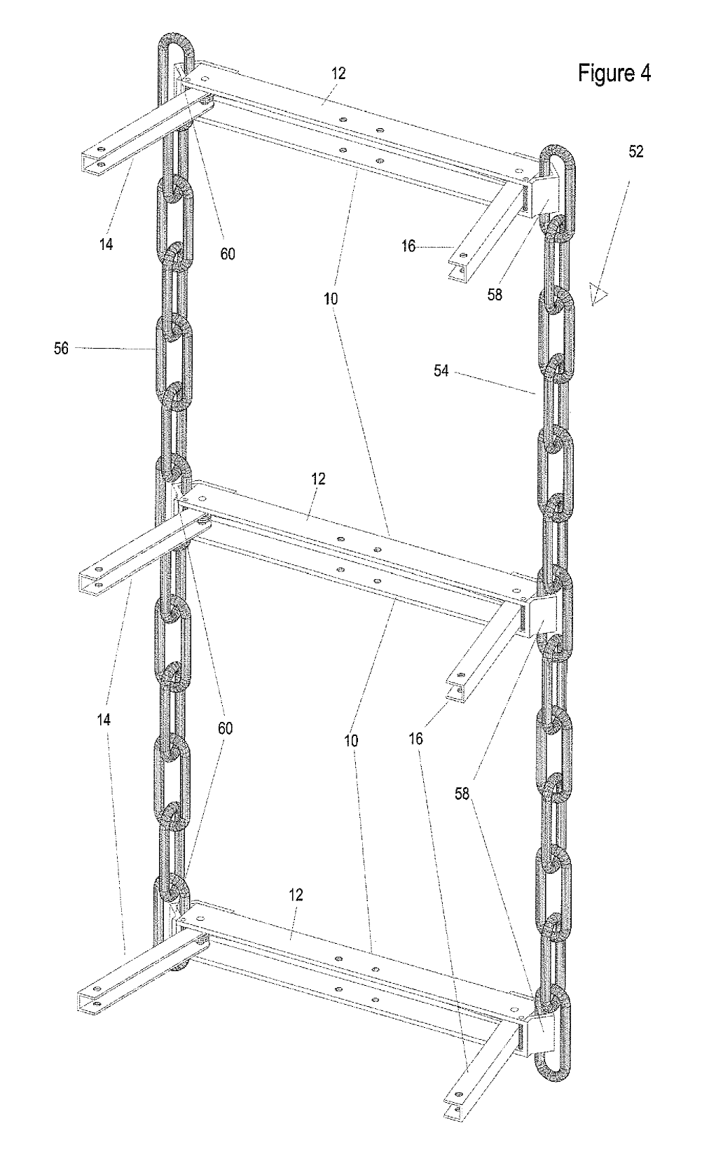

Alternatively, securement may be achieved a piece of flat steel stock formed into a loop that goes through the chain rung at each of its ends and is attached to the back of the rung. As illustrated in FIG. 3a, each of the ends 24a wraps around and goes through a respective chain link and then slides into the U-channel which forms the rung. Screw bolts are attached through the flat stock on the back of the rung, through the rung and through the flat stock inside the U-channel portion of the rung. Welding may be used to reinforce the structure at appropriate points on the rung.

In a preferred embodiment of the invention, rigid metal plate securement 24 has a pair of holes 29 at each of its ends and follows a path parallel to front 31 of rung 12, bends around the corner of rung 12 obliquely away from and then toward the end of rung 12 forming a V-shape (where it is spot welded at spot welds 27), after which it returns parallel to itself first in a V-shape and then around the corner of the back of the rung 12. Accordingly, in the bent configuration described above, both holes 29 overlie each other.

In accordance with a preferred embodiment, prior to the installation of screw 25 or, alternatively, welding, flexible and bendable side supports 54 and 56, which comprise chains (or other flexible bendable material with sufficient structural integrity to hold the rung properly in place), may be secured by passing bent rigid metal plate 24 through a link of the chain, thus securing the chain to rung 12. Once the chain has been put in position, screw 25 may be passed through holes 29 to secure the ends of metal plate 24 to rung 12 which is provided with a hole for receiving sheet metal screw 25. Thus, chains 54 and 56 are reliably and securely held in position by metal plate 24 between sheet metal screw 25 and welds 27.

Referring to FIG. 3, other details of the components are illustrated. The outer casing of stepping rung 12, is made from a single piece of aluminum or steel or rigid PVC or other suitable material which is extruded, bent or cast with, for example, a U-shaped cross-section.

Holes 26, 28, 30, and 32 are drilled proximate the outer ends of each rung 12. Pins 18 and 20, which may optionally have serrated ends, are friction fitted, welded or otherwise anchored in holes 28 and 30, respectively. Alternatively, nuts and bolts, or pop-rivets or other suitable members may be used in place of the pins. At the same time, pins 18 and 20 are loosely fitted in holes 40 and 42, respectively. Holes 40 and 42 in arms 14 and 16 are slightly larger in diameter than the diameter of pins 18 and 20, allowing arms 14 and 16 to freely rotate thereon.

Stop pins 34 and 36, which may optionally have serrated ends (or other suitable anchoring structure), are mounted and friction fitted in holes 32 and 26, respectively, and positioned to limit movement of arms 14 and 16 at a position which is substantially vertical to rung 12, or, if more stability is desired to a position about 10 degrees beyond the vertical, whereby arms 14 and 16 extend out from rung 12, to form a 90 degree or larger angle (e.g. 100 degrees).

Because top surface 37 of rungs 12 is flat, the force of a foot resting on the rung will tend to cause the top surface 37 and the extended arms 14 and 16 to extend substantially parallel to the ground, thus achieving a good separation from the outside wall of the building.

Two holes, 38, are drilled in the central portion of surface 37 of rungs 12 in order to receive locking pin assembly 22 (or a stiff/rigid wire). The expandable arms, 14 and 16, are made out of aluminum which is extruded, bent or cast with a roughly U-shaped cross-section. In accordance with the preferred embodiment, the locking pin assemblies 22 associated with each of the rungs 12 are all connected to, for example, a single anchor line 39, which pulls the pin assemblies out of all the rungs as the ladder 10 is deployed. In the case of the stiff/rigid wire, once the chain and rung assembly is pulled off the stiff/rigid wire, the expandable arms are released to their full open position to form a stand off from the building.

In accordance with a further preferred embodiment, the locking pin assemblies 22 associated with each of the rungs 12 are all connected at points along anchor line 39 which are separated by a distance equal to or less than the distance between adjacent rungs 12. This likely results in pulling the pin assemblies 22 out of the rungs one at a time as the ladder 10 is deployed, as a result of tossing or individual application of the feet to the rungs by the individual using the ladder. In connection with this, it is noted that the anchor line 39 is anchored to a point where the anchor line 39 restrains each respective pin assembly 22 from moving as low as its respective rung 12, thus ensuring the removal of the pin assembly no later than when foot pressure is applied by the individual escaping using the ladder.

Holes 44 and 46 are drilled into the ends of extendable arms 14 and 16 opposite holes 40 and 42, respectively. Locking pin 22 passes through and holds the extendable arms 14 and 16 in the closed position illustrated in FIG. 1 prior to deployment of ladder 12.

Conversely, metal springs 48 and 50 are mounted inside the extendable arms 14 and 16 on pins 18 and 20, respectively. Metal springs 48 and 50 exert an outward force on the swing arms, and against the rigid metal plate 24 located inside the stepping rung 12. Springs 48 and 50 are illustrated in the compressed position in the exploded perspective of FIG. 3. As alluded to above, springy living hinges, for example made of plastic, or other spring type mechanisms may be used in place of the springs to deploy the arms.

When the locking pin 22 is removed along the path described by arrow 13, the springs force out extendable arms 14 and 16. Extendable arms 14 and 16 continue to move out along the path defined by arrows 15 and 17 until extendable arms 14 and 16 are stopped by pins 36 and 34, respectively, and assume the position shown in FIG. 2.

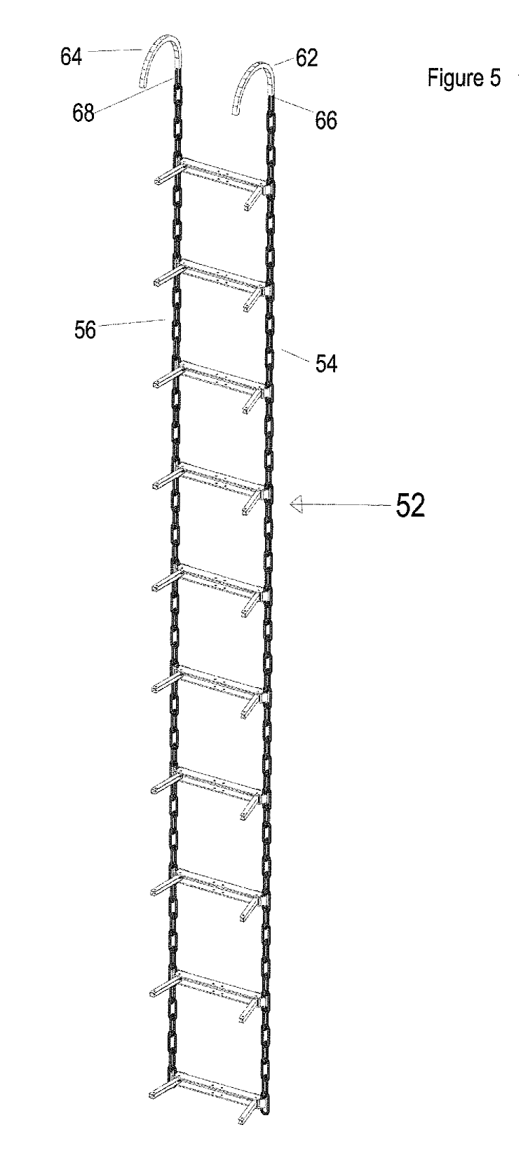

Referring to FIG. 4, the fire escape ladder 10 is comprised of a series of rungs 12 attached to the flexible and bendable side supports 54 and 56, crafted out of rope, chain, or other suitable material, using a series of clamps or welds, at locations 58 and 60. The attachment is mounted centrally with respect to the width of the rungs such that the top surface of rung 12 will orient perpendicular to wall of the burning building, when the expandable arms, 14 and 16, are in their open position.

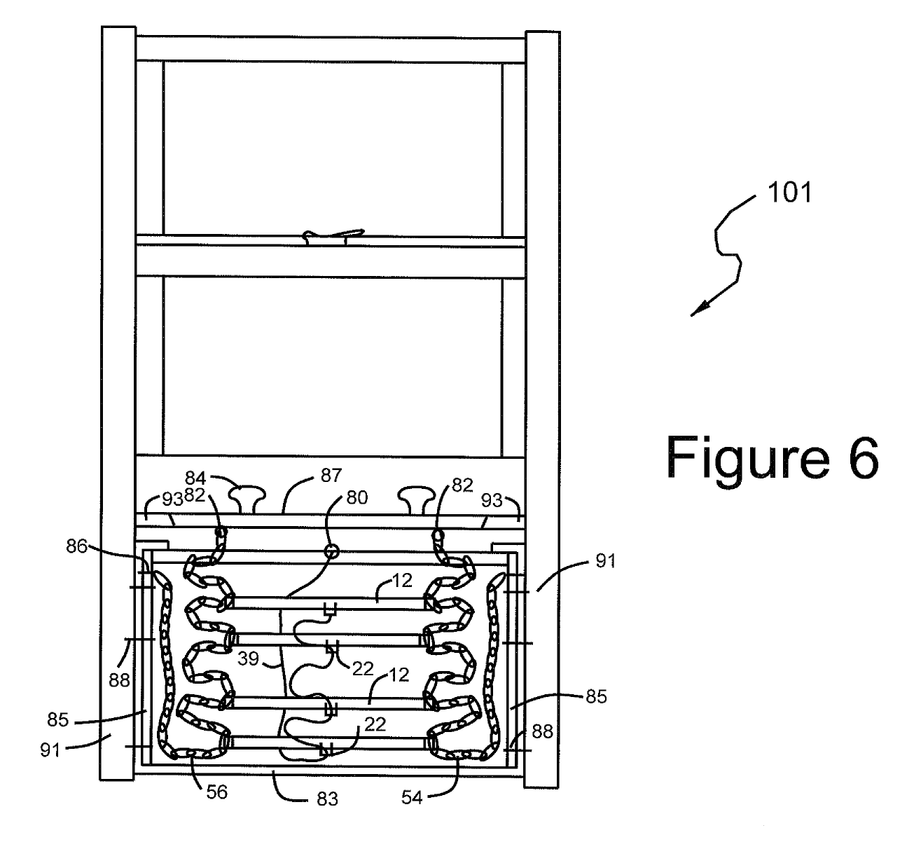

Turning to FIGS. 1-5, the use of the fire escape ladder 10 may be understood. As shown in FIG. 4, the fire escape ladder 10 will fully deploy with the extendable arms, 14 and 16, in their open position after pin assemblies 22 are removed from rungs 12. This happens when ladder 10 is lowered out of a window to allow a safe and easy climb down to the ground. Referring to FIG. 5, aluminum or steel hooks 62 and 64 located at the top ends of the flexible and bendable side supports, 52 and 56, at locations 66 and 68, respectively, and attached using clamps or welding, allow for the Fire Escape ladder Assembly 52 to be quickly attached to a window sill. Alternatively, a simple stiff or bendable metal wire may be used in place of the pin assemblies as detailed more fully below.

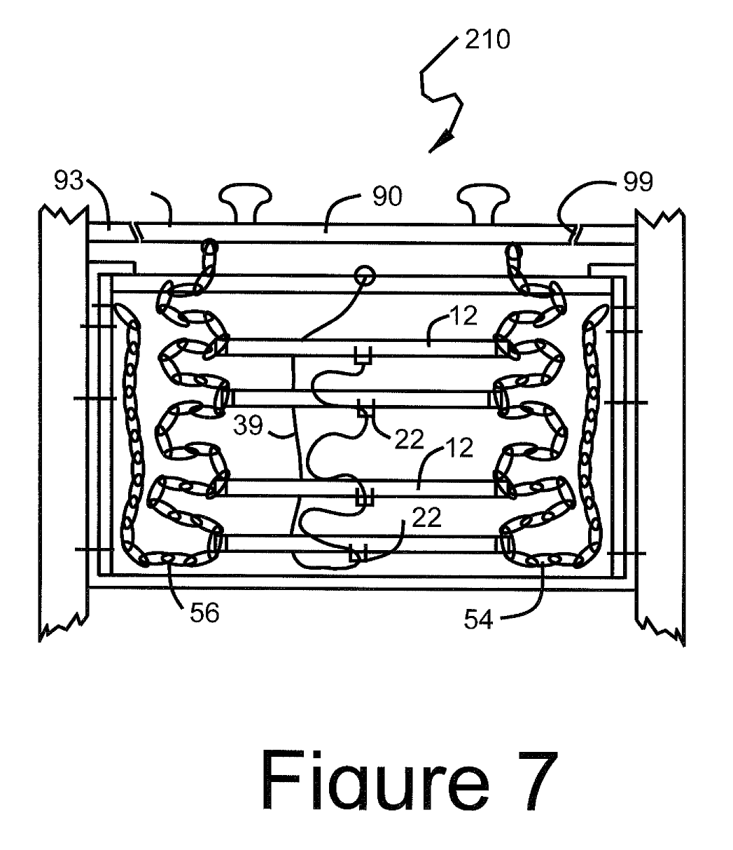

An alternative embodiment of the present invention, constructed much like the embodiment of FIGS. 1-5, in which the inventive ladder is built into a window 101 is illustrated in FIG. 6. In accordance with this embodiment, the fire escape ladder portion of the original equipment window is hidden behind the sheetrock of the wall. Accordingly, it does not affect the aesthetics of the room and in many cases it may be possible to put objects or appropriate furniture in front of the window without impeding the functionality of the fire escape ladder. Anchor line 39 is secured by a fastener 80 which is welded to a plate 81, which, in turn, is welded to a metal box 83. A pair of metal plates 85 lend strength to box 83. Fasteners 82 secure chains 54 and 56 to removable sill 87 which also serves as the bottom rung of the ladder. The other end of chains 54 and 56 are secured by fasteners 86 to metal plates 85. Sheet rock screws 88 secure box 83 between vertical window support members.

When it is desired to use the inventive ladder, the user opens the window and the sill 87 is removed from the remaining support portions 93 of the sill by grasping knobs 84 and pulling up. The ladder is then tossed out the window, pulling the pins from the rungs and deploying the standoff arms creating a gap between the ladder and the side of the building.

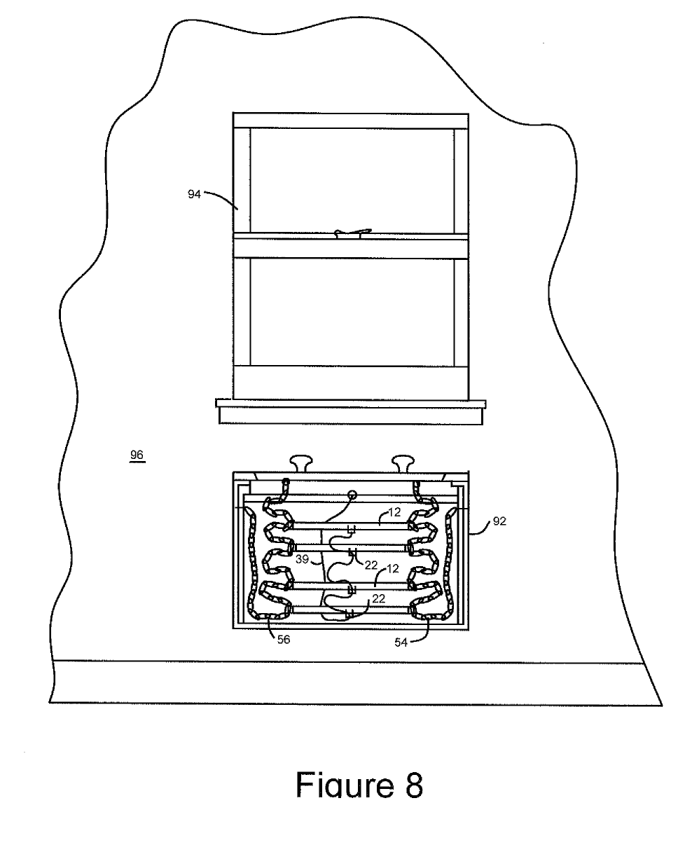

A particularly preferred embodiment of the invention in the context of a retrofit is illustrated in FIG. 7. The ladder assembly is similar to the earlier figures, except that a removable sill and lid 87 is created by sawing a gap 99 in the existing sill leaving support portions 93 in place. Alternatively, the entire portion of the stool under the window may be removed. The ladder assembly 210 is secured between studs in the wall after the wall has been opened up. After installation, the wall is repaired in conventional fashion. Box 83 is dimensioned for a tight fit between studs which are normally on 16 inch centers. It is noted that a portion of the 2×4 sill plate which normally underlies an existing window has been sawn away, as its support function is taken over by fire escape ladder assembly 210.

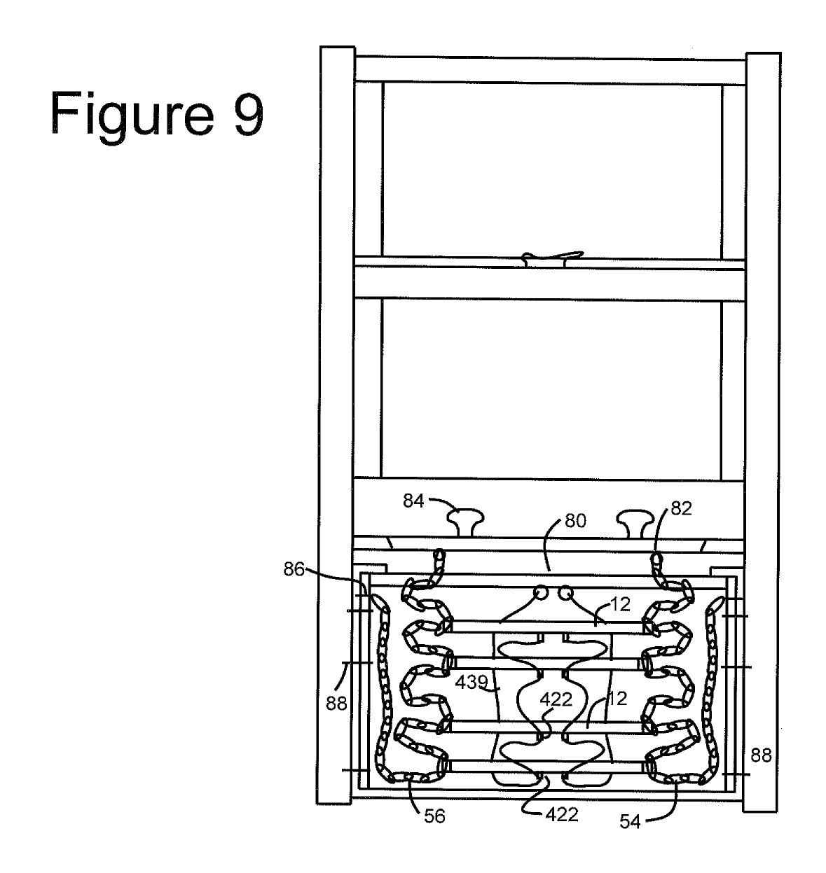

FIG. 8 illustrates another alternative, in which a ladder assembly 310 is secured over the wallboard 96 under window 94 and inside a room, leaving box 92 exposed to view. Alternatively, it is also possible to locate the box containing the fire escape ladder outside of the building. A yet further alternative is a possibility of mounting the lid 87 on the side of the box.

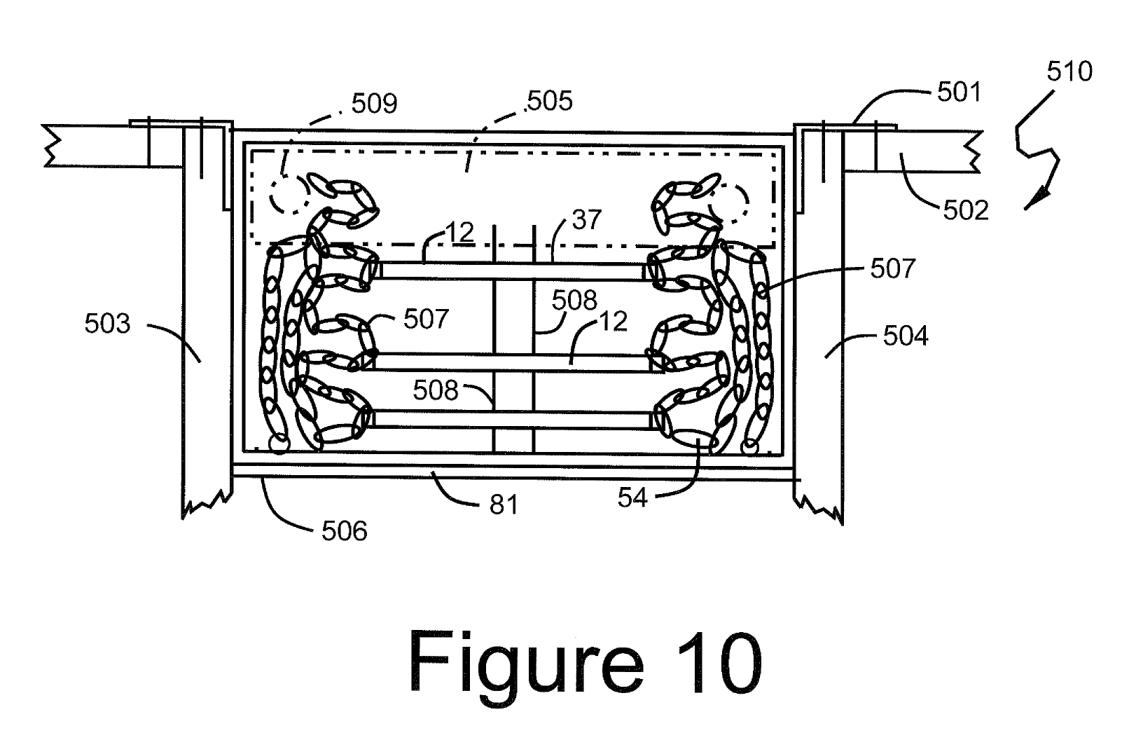

FIG. 9 illustrates another alternative similar to the embodiment of FIG. 6, except that the two tang pins are replaced by two sets of single pins 422 tied together by a pair of lines 439.

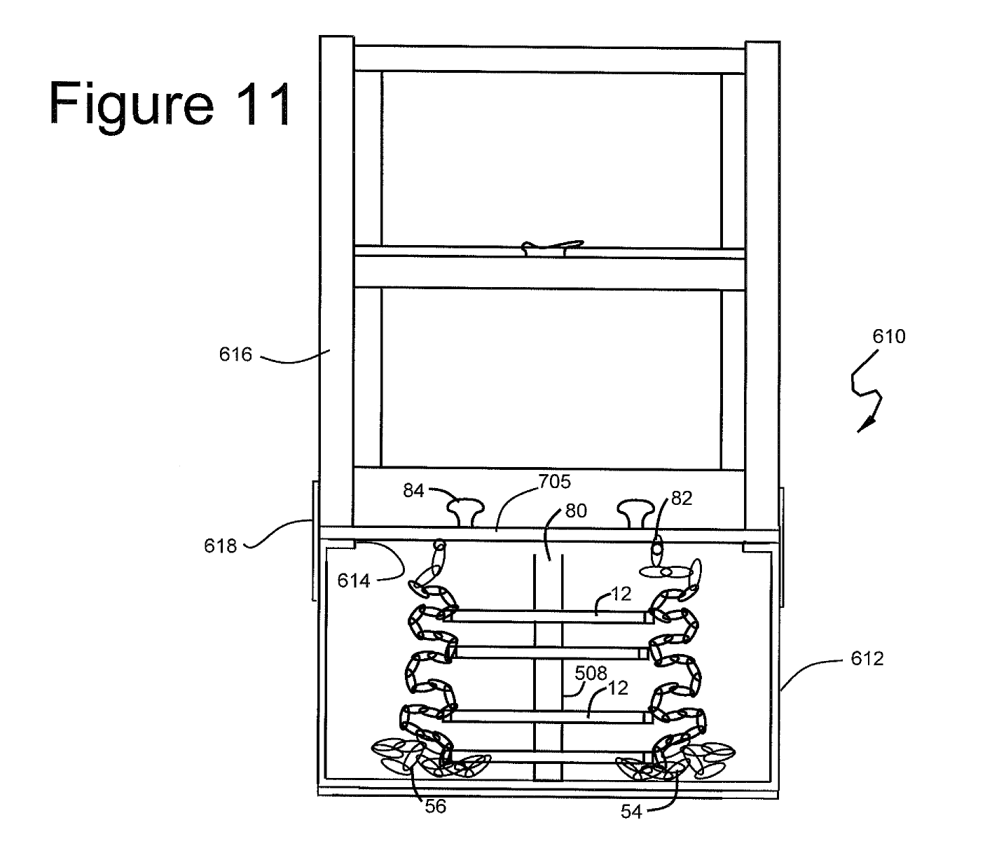

Referring to FIG. 10, yet another alternative embodiment of the invention is illustrated. In this embodiment, fire escape device 510 is installed as shown after an existing window has been removed. The fire escape device 510 is secured in place by a pair of right angle brackets 501, which are secured by sheet rock screws to existing studs 502, jack stud 503 and a cripple 504. A lid 505 is secured over an opening in box 506. Overlying the opening in box 506 is a similar opening in the drywall. Lid 506 is secured in place to the drywall, for example by magnets, and weatherproofed by weather-stripping. Chains 507 are secured at their ends to lid 505.

The extendable arms of the embodiment of FIG. 10 which is much like the embodiment of FIG. 6 except for the differences noted and illustrated, are held in position by a pair of stiff wires 508 which pass through the holes in the rungs and extendable arms. Wires 508 are secured to plate 81. In accordance with the embodiments of the invention illustrated, a large number of rungs, for example nine rungs, may be employed, however only three rungs are illustrated in the schematic view of FIG. 10 and the other figures for purposes of simplicity of the illustration and clarity of understanding.

When it is desired to use the inventive fire escape, lid 505 is pulled by knobs 509 from the wall to which it is mounted by any suitable means, for example magnets, thus pulling chains 507 and rungs 12 out from the system and deploying them outside the side of the building. This results in removing wires 508 from rungs 12, after which the rungs that were tossed out the window forming an escape ladder. The window is typically positioned above fire escape assembly 510. In accordance with a preferred embodiment, weather-stripping may be used along the periphery of lid 505 to prevent cold air from entering the room from the cavity of the wall, as noted above.

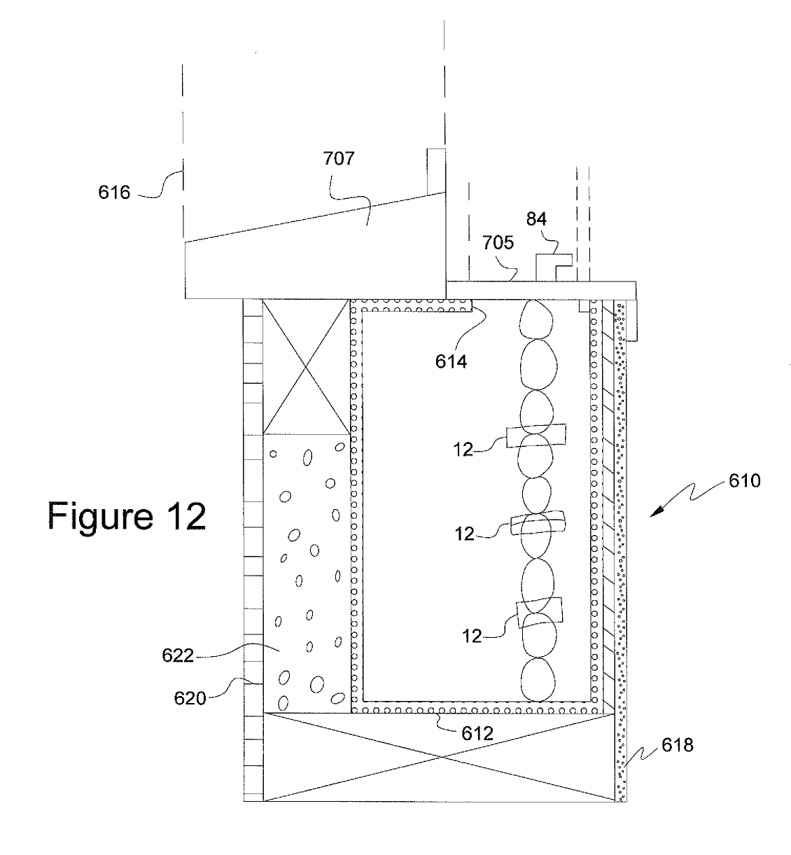

Turning to FIG. 11, an original equipment window 610 for use in new construction is illustrated. Windows 610 includes wires 508 for releasing the extendable arms, whose construction, like the rest of the window illustrated in FIG. 11 is similar to that of the embodiment illustrated in FIG. 6 except for the differences discussed below. More particularly, in accordance with the invention, the bottom member of the wood framing is removed (leaving sill 707 at the bottom of the window portion of the unit) and replaced by a box 612 comprising the fire escape system of the present invention. A lid 705 overlies an opening 614 in box 612 and is shown in phantom lines to reveal the structure of the other components.

Box 612 is secured to the wood framing 616 by straps 618 which are held in place by sheet rock screws or any suitable fastener. In this manner the manufacture of a conventional window may be easily modified to accept the box 612 of the inventive fire escape system. In the embodiment of FIG. 11, wood framing 616 of the window may extend out from the exterior of a building, as illustrated in the cross-sectional schematic view of FIG. 12. This leaves plenty of room for lid 705, as illustrated most clearly in FIG. 12. Because the inventive system uses an extendable arm which is contained within rungs 12, the depth of box 612 is relatively shallow allowing the same to be contained within the external wall of the building between the drywall 618 and the external siding 620 with room to spare, allowing the introduction of insulation 622.

When it is desired to use the window of FIG. 11 for escape, lid 705 is removed using knobs 84. Thus, rungs 12, together with chains 54 and 56 are removed, sliding the rungs off wires 508, thus allowing deployment of the ladder with the deployed extendable arms out the window of the building.

While illustrative embodiments of the invention have been described, it is noted that various modifications will be apparent to those of ordinary skill in the art in view of the above description and drawings. Such modifications are within the scope of the invention which is limited and defined only by the following claims.

What is claimed is:

1. Apparatus for escaping from a building through a window, comprising:
(a) a plurality of rungs having first and second ends;
(b) a first side support coupled to said first ends of said rungs, said first side support having an upper end;
(c) a second side support coupled to said second ends of said rungs, said first side support having an upper end;
(d) a securement assembly coupled to the wall of a building adjacent a window for providing egress;
(e) a first securement for securing the upper end of said first side support to said securement member;
(f) a second securement for securing the upper end of said second side support to said securement member;
(g) a plurality of first arms, each positioned proximate the first ends of a respective one of said rungs and each moveably mounted to go from a retracted position to an extended position; and
(h) a plurality of first arms, each positioned proximate the first ends of a respective one of said rungs and each moveably mounted to go from a retracted position to an extended position.

2. Apparatus as in claim 1, further comprising:
(i) a wire-like locking member for retaining said arms in the retracted position.

3. Apparatus as in claim 2, wherein the locking members are pins passing through holes in the arms and the rungs, said locking members being coupled to a single line secured to said securement assembly.

4. Apparatus as in claim 1, wherein each of said arms is associated with a spring that urges the arm from the retracted position to the extended position.

5. Apparatus as in claim 4, Apparatus as in claim 1, further comprising:
(i) a plurality of locking members for retaining said arms in the retracted position, wherein the locking members are pins passing through holes in the arms and the rungs, said locking members being coupled to a single line secured to said securement assembly.

6. Apparatus as in claim 5, wherein said first and second side supports comprise chains.

7. Apparatus as in claim 1, wherein said first and second side supports comprise chains.

8. Apparatus as in claim 1, wherein said rungs are generally u-shaped and contain said arms.

9. Apparatus as in claim 1, wherein said securement assembly coupled to the wall of a comprises a metal bar.

10. Apparatus as in claim 1, wherein said securement assembly coupled to the wall comprises a window and frame assembly.

11. Apparatus as in claim 1, wherein said securement assembly coupled to the wall comprises a box adapted to mounted internally of a wall.

12. Apparatus as in claim 1, wherein said securement assembly coupled to the wall comprises a box adapted to mounted externally of a wall.

13. Apparatus as in claim 1, further comprising:
(i) a plurality of locking members for retaining said arms in the retracted position.

14. Apparatus as in claim 1, further comprising:
(i) a pair of wire-like locking members for retaining said arms in the retracted position.
